(19) United States
(12) Patent Application Publication
(10) Pub. No.: US 2024/0235026 A1
(43) Pub. Date: Jul. 11, 2024

(54) DUAL BAND ANTENNA FOR MOBILE ELECTRONIC DEVICES

(71) Applicant: Meta Platforms Technologies, LLC, Menlo Park, CA (US)

(72) Inventors: Navid Barani Lonbani, Bellevue, WA (US); Aobo Li, Saratoga, CA (US); Javier Rodriguez De Luis, Kirkland, WA (US); Liang Han, Sunnyvale, CA (US)

(21) Appl. No.: 18/151,145

(22) Filed: Jan. 6, 2023

(51) Int. Cl. H01Q 5/48; H01Q 5/50

(52) U.S. Cl. CPC H01Q 5/48; H01Q 5/50

(57) ABSTRACT

The disclosed system may include a main logic board (MLB) that includes a ground plane, an antenna feed that is electrically connected to the MLB, an antenna arm electrically connected to the antenna feed, and a slot antenna formed into at least part of the MLB. The slot antenna may be electrically connected to the antenna feed. Various other apparatuses and mobile electronic devices are also disclosed.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 illustrates an embodiment of a dual band antenna that may be implemented in mobile electronic devices.

FIG. 2 illustrates a general explanation of one or more principles of operation that the embodiments herein may implement.

FIG. 3 illustrates an embodiment of a dual band antenna that may be implemented in mobile electronic devices such as a smartwatch.

FIG. 4 illustrates a chart showing efficiency simulations for a dual band antenna such as that shown in FIG. 3.

FIG. 5 illustrates an embodiment of a dual band antenna that may be implemented in mobile electronic devices for mmWave operation.

FIG. 6 illustrates a chart showing S-parameter simulations for a dual band antenna such as that shown in FIG. 5.

FIG. 7 illustrates an embodiment of an array of dual band mmWave antennas that may be implemented in a mobile electronic device.

FIG. 8 is an illustration of exemplary augmented-reality glasses that may be used in connection with embodiments of this disclosure.

FIG. 9 is an illustration of an exemplary virtual-reality headset that may be used in connection with embodiments of this disclosure.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

The present disclosure is generally directed to wideband antenna designs and implementations that may be used in a variety of different mobile electronic devices. In some past cases, narrowband loop antennas or monopole antennas were used in mobile electronic devices. Such narrowband antennas often operated at <10% fractional bandwidth (i.e., where fractional bandwidth is a measurement that takes frequency into account (e.g., fractional bandwidth equals the absolute bandwidth divided by the center frequency)). To support WiFi 5G, WiFi 6E, and other wireless communication architectures, antennas may need to be capable of covering 5 GHz-7 GHz (or higher) and, in order to do so, may need to operate at >30% fractional bandwidth.

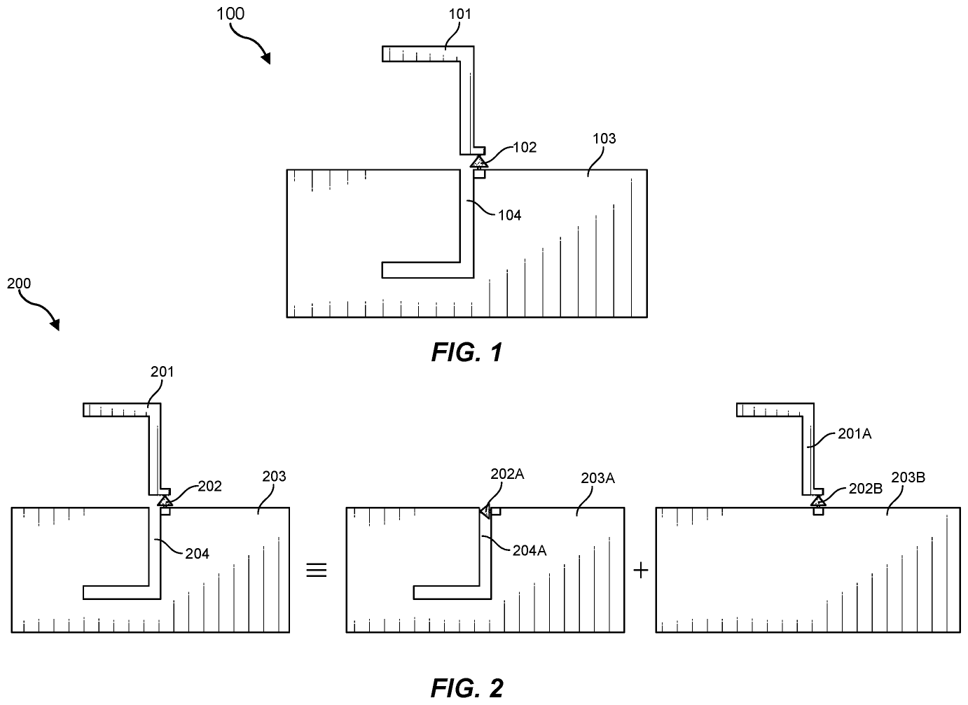

The embodiments herein describe wideband antenna designs and implementations that, at least in some cases, combine the characteristics of monopole antennas with those of slot antennas. These combined antenna designs may be configured to operate in multiple different frequency ranges and may be provide ^{˜}40% (or more) fractional bandwidth. This may allow the antennas described herein to work not only for 5G and 6E implementations, but also for mm-wave (60 GHz) high-throughput implementations. In such mmWave embodiments, multiple antennas using the wideband designs described herein may be positioned in an array. The antennas in such arrays may provide ultra-high speed data transfers at high (e.g., 24-60 GHz) frequencies. Each of these embodiments will be described in greater detail below with regard to FIGS. 1-9.

Features from any of the embodiments described herein may be used in combination with one another in accordance with the general principles described herein. These and other embodiments, features, and advantages will be more fully understood upon reading the following detailed description in conjunction with the accompanying drawings and claims.

FIG. 1 illustrates a system 100 that has multiple different components. Those components, for example, may include a main logic board (MLB) that includes a ground plane 103. The MLB may be any type of printed circuit board (PCB) that includes electronic components such as processors, memory, electrical traces, antenna feeds, controllers, or other electronic components. The “ground plane” 103 of the MLB may refer to a solid conductive plate, may refer to a conductive plate with one or more holes or apertures, may refer to one or more conductive traces, or may refer to other conductive elements that form an electrical ground. In addition to the ground plane 103, the system 100 may also include an antenna feed 102. The antenna feed 102 may be electrically connected to the ground plane 103 of the MLB. The antenna feed 102 may include one or more antenna feed components including tuners, amplifiers, signal processors, radios, impedance matching circuits, or other associated antenna feed components or elements.

The antenna feed 102 may be electrically connected to the ground plane 103 of the MLB and may also be electrically connected to an antenna arm 101. The antenna arm 101 may include conductive material that may be arranged in a specified pattern or shape. In some cases, the antenna arm 101 may be a monopole antenna that may be formed in many different shapes or sizes. The system 100 may also include a slot antenna 104 that is formed into at least some portion of the ground plane 103 of the MLB and is a mirrored version of the monopole arm with respect to the horizontal plane. The slot antenna 104, like the antenna arm 101, may be electrically connected to the antenna feed 102. In this manner, the same antenna feed 102 may simultaneously drive both the antenna arm 101 and the slot antenna 104.

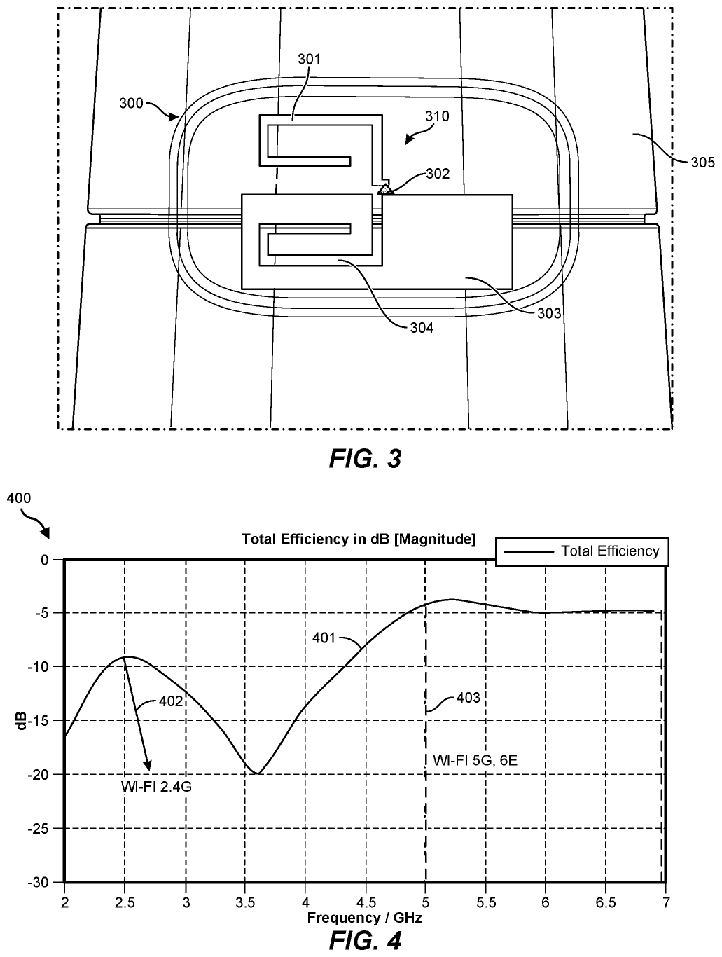

In some cases, the antenna arm 101 may be formed in a specific shape and/or with specific dimensions. For instance, as shown in FIG. 1, the antenna arm 101 may be formed in the shape of an “L” with an extended portion that is electrically connected to the antenna feed 102. In other cases, for example, as shown in FIG. 3, the antenna arm may be formed in the general shape of a rectangle, where the length of the antenna arm wraps around across three 90-degree corners. Many other shapes, turns, turning angles, heights, widths, or other dimensions may be used in the embodiments herein.

In some cases, the dimensions of the antenna arm 101 may be changed in different embodiments. For example, each of the two segments in the “L” shape antenna arm 101 of FIG. 1 may be longer or shorter, wider or skinnier, thicker or thinner, etc. In some cases, for instance, forming the antenna arm 101 with longer-length segments may result in an antenna that is tuned to lower frequencies. Shorter length segments may result in the opposite effect, namely, that the antenna arm 101 is tuned to operate at higher frequencies. Other changes may also be made to the length, width, etc. of the antenna arm 101, with corresponding changes being made to the slot antenna 104. These changes, as will be explained further below, may be used to alter the various resonances of the antenna arm 101, the slot antenna 104, or the combined antenna as a whole.

The slot antenna 104 may also be formed in different shapes and sizes to match the shape and size of the antenna arm 101. To mirror the antenna arm 101, the slot antenna 104 may include sections having different widths, different lengths, and/or different shapes. In some cases, the slot antenna may be formed in a shape that fully mirrors (or at least substantially mirrors) the shape of the antenna arm 101. Thus, for example, as shown in FIG. 1, the slot antenna 104 and the antenna arm 101 may both be formed in the shape of an “L.” And, in this example, both components may be formed with similar (or the same) dimensions, with each consuming a same or similar area on the system 100, the slot antenna 104 mirroring the antenna arm 101.

In some cases, the slot antenna 104 may be formed in a shape that mirrors only the shape of the antenna arm 101, while in other cases, the slot antenna 104 may be formed in both the shape and the dimensions of the antenna arm 101. At least in some cases, the slot antenna 104 and the antenna arm 101 may operate together to create a self-complementary, wideband antenna. This self-complementary antenna may combine the characteristics of a slot antenna and a monopole antenna to create a wideband antenna that covers more frequencies and has more desirable resonances than either antenna would have by itself. Thus, while previous mobile devices implemented narrowband monopole or loop antennas that operated at a low fractional bandwidth (e.g., ^{˜}10%), the embodiments herein may combine slot and monopole antennas and provide a combined fractional bandwidth (e.g., ^{˜}40%) that is much higher and can operate efficiently across many more frequency bands, including 5G, 6G, and even mmWave frequency bands.

FIG. 2 illustrates a self-complementary antenna 200 that includes a conductive antenna arm 201, a slot antenna 204 formed into or as part of a ground plane 203, and an antenna feed 202. As can be seen in FIG. 2, at least in some embodiments, the self-complementary antenna 200 may be a combination of a slot antenna 204A formed into ground plane 203A, electrically connected to an antenna feed 202A, and a monopole antenna 201A that, itself, is connected to an antenna feed 202B. In each case, the antenna feeds 202A/202B may be electrically connected to a corresponding ground plane 203A/203B. These monopole and slot antennas 201A/204A may be combined and may result in the self-complementary antenna 200.

As noted above, the self-complementary antenna 200 may include advantageous characteristics that neither antenna, by itself, can provide. For instance, as noted above, a monopole antenna (or a slot antenna) by itself is a narrowband antenna that operates within a relatively narrow frequency band and at a relatively low fractional bandwidth. In contrast, the self-complementary antenna 200 described herein may combine the efficiencies of each antenna and, when operated together, may operate at a much higher fractional bandwidth across a much wider bandwidth.

Moreover, while the monopole antenna by itself may have a relatively low impedance, and while the slot antenna by itself may have a relatively high impedance, when the two are combined, the impedance value for the combined antenna may be an intermediary value that is between the high and low values of the antennas by themselves. Still further, when taken as individual antennas, each antenna needs to have its own antenna feed. In contrast, the embodiments herein may implement a single antenna feed that drives both antennas simultaneously.

FIG. 3 illustrates an embodiment of a combined antenna that may be part of a mobile electronic device such as a smartwatch 300. In some cases, the smartwatch 300 may be positioned on the user's arm 305 or other part of their body. The smartwatch 300 may include a combined antenna 310 that includes both an antenna arm 301 and a slot antenna 304, both of which may be connected to the same antenna feed 302. The slot antenna 304 may be formed into a ground plane of an MLB or PCB. The antenna arm 301 and the slot antenna 304 may be operated simultaneously as a combined antenna 310 fed by the antenna feed 302.

In some cases, as noted above, the slot antenna 304 may have a relatively high impedance value, while the antenna arm 301 may have a relatively low impedance value. In cases where the antenna arm 301 and the slot antenna 304 are driven together by the antenna feed 302, the higher impedance value of the slot antenna and the lower impedance value of the antenna arm may combine to exhibit an intermediary impedance value that is between the high and low impedance values. This may allow the combined antenna 310 to operate using a single impedance matching circuit, instead of each antenna having its own impedance matching circuit. The intermediary impedance value may apply to and may be used with the combined antenna 310 across multiple different wireless frequency bands.

In some cases, the combined antenna may be inherently matched. In such cases, the combined antenna, including both the antenna arm 301 and the slot antenna 304, may be configured to function without an impedance matching circuit on the MLB. By ensuring that the combined antenna is inherently matched, an impedance matching circuit may be avoided altogether. At least in some cases, this may reduce the number of components on the MLB, saving space for other components on the MLB and saving battery life as a result of the smaller number of components.

Furthermore, in some cases, the antenna arm 301 and the slot antenna 304 of the combined antenna 310 may be configured in parallel. Thus, in such cases, any transmission or reception characteristics of the antenna arm 301 or the slot antenna 304 may be initially set in parallel or may be changed at a later time in parallel. Accordingly, for example, antenna gain may be increased or decreased for both antennas simultaneously. Additionally or alternatively, impedance matching characteristics may be altered for both antennas simultaneously. This ability to configure the antennas in parallel may provide added efficiency to the smartwatch 300 or to other mobile devices that may implement the combined antenna 310.

As shown in FIG. 3, the antenna arm 301's design may include at least three straight segments that are intermediated by at least two different turning segments. In some cases, the different turning segments may include 90 degree turns, or may include turns that are oriented in a different manner. In the embodiment shown in FIG. 3, the antenna arm 301 and the slot antenna 304 may have similar shapes and similar dimensions. Each may include three segments that are intermediated by 90-degree corners. Other types of more gradual turns or different degrees of turns may be used, different segment lengths, different segment widths, different numbers of segments, different thicknesses, or other shapes may be used when designing the combined antenna 310. In some embodiments, the slot antenna 304 may include three different slots that correspond to, and that mirror in position, the at least three straight segments and the at least two different turning segments of the antenna arm 301, as generally shown in FIG. 3.

FIG. 4 illustrates a chart 400 that shows at least two resonances in an efficiency line 401 that spans from 2 GHz to 7 GHz. A notable first resonance appears at point 402. This resonance generally corresponds with WiFi 2.4 GHz. A second resonance appears at point 403. This resonance generally corresponds with WiFi 5 GHz & 6E. As can be seen in chart 400, a combined antenna (e.g., 310 of FIG. 3), that includes both an antenna arm and a slot antenna that are operated simultaneously as a combined antenna fed by the antenna feed, may provide wideband coverage that may have optimal resonances at WiFi 2.4 GHz and 5 GHz & 6E frequencies.

In some cases, the first resonance at point 402 of the combined antenna may be tunable by changing one or more characteristics of the antenna arm (e.g., 301). Thus, for example, if the antenna arm 301 is designed to be longer or more meandering with more turns, the first resonance may correspondingly shift lower to lower frequencies. The second resonance at point 403 may be tuned by changing the size of the ground plane 303. Thus, for example, making the ground plane larger may tune the combined antenna to cover higher frequencies. Accordingly, at least in some cases, characteristics of the antenna arm 301 and/or of the ground plane 303 of the MLB may be altered (e.g., larger or smaller size, variations in shape, etc.) to tune and produce resonances at specific, desired frequencies.

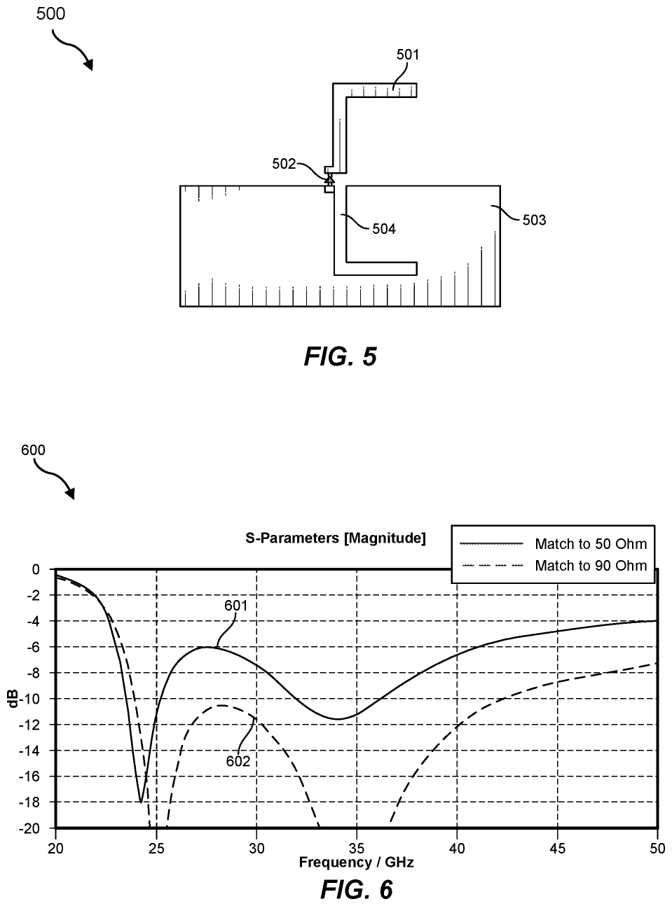

FIG. 5 illustrates an embodiment of a combined antenna 500 that may include multiple components including an antenna arm 501, a slot antenna 504 that is formed in an MLB or PCB ground plane 503, and an antenna feed 502 that is configured to drive both the antenna arm and the slot antenna simultaneously. The combined antenna 500 may be dimensioned to operate as a wideband antenna for mmWave frequencies. For instance, at least in some cases, the antenna arm 501 may be between 0.5-1 mm, or between 1.0-1.2 mm, or between 1.2-1.4 mm in length and/or height.

The slot antenna 504 may be formed as a mirror image to the antenna arm 501 and may have similar dimensions. The ground plane 503 may be between 1.0 mm and 1.75 mm tall and between 3.25 and 3.75 mm wide. These are example sizes, and other sizes may be used for mmWave applications. As shown in chart 600 of FIG. 6, the combined antenna 500 may operate most efficiently (based on S-parameters) at approximately ^{˜}24 GHz and at ^{˜}34 GHz. Although, as can be seen in the resulting parameter plot lines (601 for a 50 Ohm matched line and 602 for a 90 Ohm matched line), the combined antenna 500 may operate efficiently at many different frequencies over a wide band stretching between ^{˜}24 GHz and ^{˜}50 GHz.

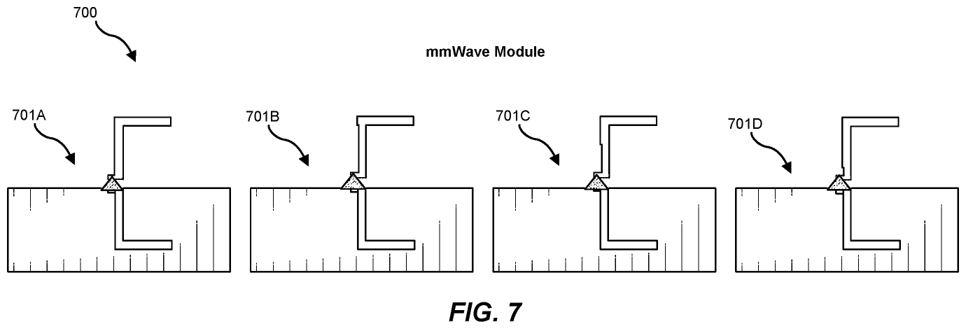

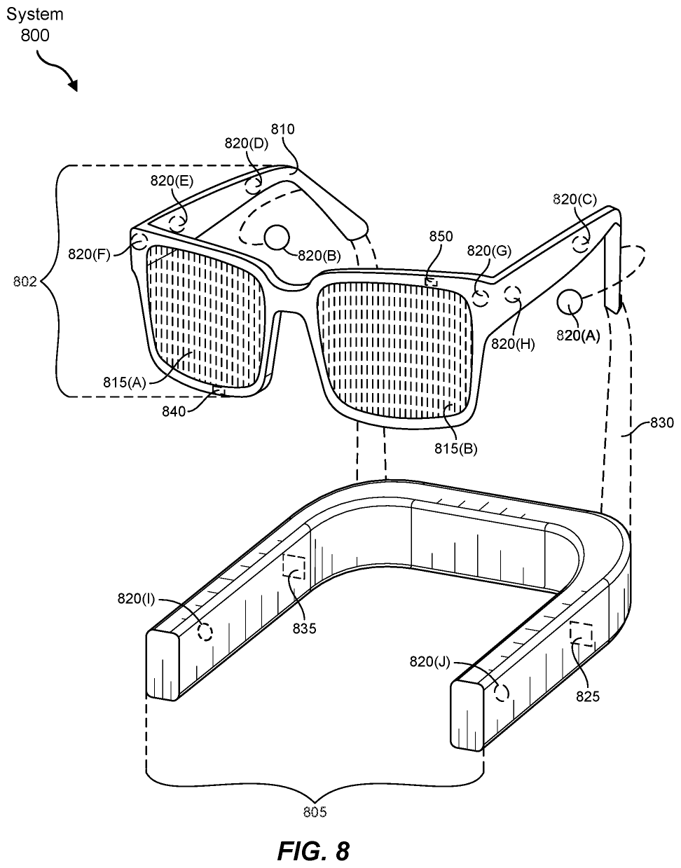

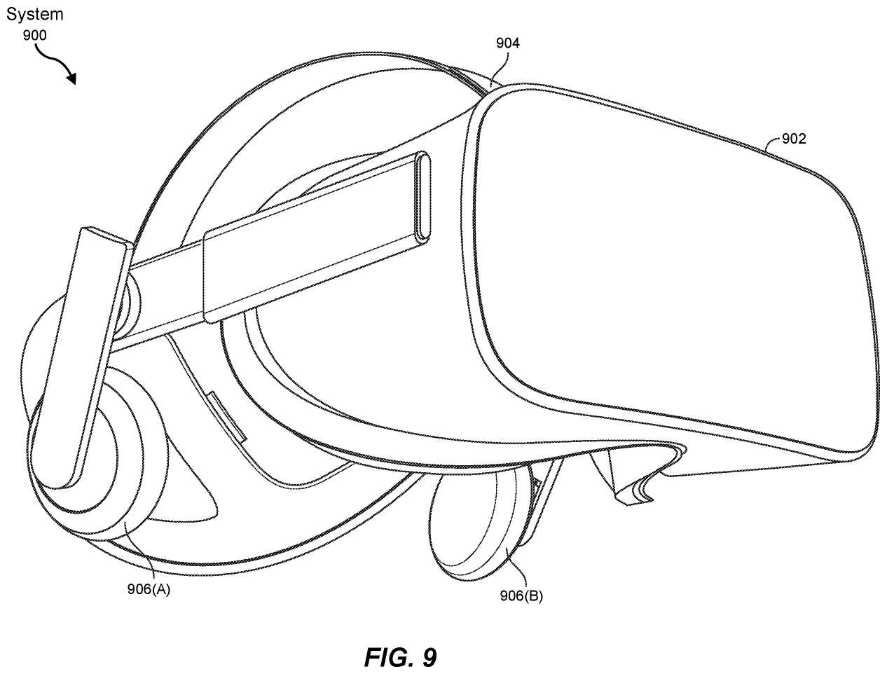

The combined antenna 500 of FIG. 5 may be used by itself as an mmWave antenna or may be used in combination with other antennas. For example, as illustrated in FIG. 7, the combined antenna may be used in an array of the same or similar antennas. Such an array of combined antennas may be implemented within a mobile electronic device such as a smartphone, smartwatch, augmented reality device (e.g., 800 of FIG. 8), virtual reality device (e.g., 900 of FIG. 9), or other type of mobile electronic device. In other cases, the combined antenna (or array of antennas) may be implemented in a stationary electronic device such as an internet of things (IOT) device, a gaming console, a personal computer, or other type of stationary electronic device.

As shown in FIG. 7, an array of combined antennas 700 may include multiple combined antennas arranged in a row, column, or other arrangement within a mobile electronic device. The array of combined antennas 700 may include substantially any number of combined antennas, including more or less than the four combined antennas (e.g., 701A, 701B, 701C, and 701D) shown in FIG. 7. Each of the combined antennas may include components that are the same as or are similar to those shown in the combined antenna 310 of FIG. 3, or 500 of FIG. 5.

For instance, the combined antennas 701A-701D may each include an antenna arm, a slot antenna, an antenna feed that feeds both the antenna arm and the slot antenna, and a ground plane. In some cases, the combined antennas may be arranged horizontally in a row, while in other cases, the combined antennas may be arranged in a semi-circle, or may be angled in different direction, or may be positioned in smaller, subsequent rows (e.g., 2×2), or may be positioned in other patterns. Each of the antennas in the array may be driven together using a shared control signal, or some subset of the antennas may be driven in a different manner using different control signals. Thus, in some cases, different parts of the array of antennas 700 may act alone or in concert to send or receive wireless signals (particularly at mmWave frequencies (e.g., 60 GHz)).

In this manner, the combined antennas described herein may be implemented as stand-alone antennas or may be implemented in antenna arrays. These antennas may be dimensioned to operate at many different frequencies including 2.4 GHz or 5 GHz WiFi, 2.4 GHz Bluetooth, cellular (e.g., 5G or 6G), or other frequencies. Due to the combined characteristics of different bandwidth coverage, higher and lower impedance antennas, etc., the combined antennas described herein may operate across wide bandwidths and, at least in some cases, may be inherently impedance matched. As such, the combined antennas may be capable of operating in a mobile electronic device without having an impedance matching circuit that is part of the device's MLB. This may allow for reduced battery consumption, fewer components taking up space on the MLB, and improved robustness in design.

Other embodiments, including apparatuses and mobile electronic devices are also included herein. For instance, an apparatus according to these embodiments may include a main logic board (MLB) that has a ground plane, an antenna feed that is electrically connected to the MLB, an antenna arm that is electrically connected to the antenna feed, and a slot antenna that is formed into at least a portion of the MLB, where the slot antenna is electrically connected to the antenna feed.

Similarly, a mobile electronic device is provided may include a main logic board that has a ground plane, an antenna feed that is electrically connected to the MLB, an antenna arm that is electrically connected to the antenna feed, and a slot antenna that is formed into at least a portion of the MLB, where the slot antenna is electrically connected to the antenna feed. Other electronic devices that use the combined antennas described herein, in different shapes, in different layouts, in different configurations, are also contemplated.

### EXAMPLE EMBODIMENTS

Example 1: A system may include: a main logic board (MLB) that includes a ground plane, an antenna feed electrically connected to the MLB, an antenna arm electrically connected to the antenna feed, and a slot antenna formed into at least a portion of the MLB, wherein the slot antenna is electrically connected to the antenna feed.

Example 2: The system of Example 1, wherein the antenna arm comprises a monopole antenna.

Example 3: The system of Example 1 or Example 2, wherein the antenna arm is formed in a specified shape and with specified dimensions.

Example 4: The system of any of Examples 1-3, wherein the slot antenna is formed in a shape that mirrors the specified shape of the antenna arm.

Example 5: The system of any of Examples 1-4, wherein the slot antenna is formed in a shape that mirrors the specified shape and the specified dimensions of the antenna arm.

Example 6: The system of any of Examples 1-5, wherein the antenna arm and the slot antenna are operated simultaneously as a combined antenna fed by the antenna feed.

Example 7: The system of any of Examples 1-6, wherein a higher impedance value of the slot antenna and a lower impedance value of the antenna arm combine to exhibit an intermediary impedance value that is between the higher and lower impedance values.

Example 8: The system of any of Examples 1-7, wherein the intermediary impedance value applies to a plurality of different wireless frequency bands.

Example 9: The system of any of Examples 1-8, wherein the combined antenna is inherently matched, such that the combined antenna is configured to function without an impedance matching circuit on the MLB.

Example 10: The system of any of Examples 1-9, wherein the antenna arm and the slot antenna of the combined antenna are configured in parallel.

Example 11: The system of any of Examples 1-10, wherein the antenna arm includes at least three straight segments that are intermediated by at least two different turning segments.

Example 12: The system of any of Examples 1-11, wherein the at least two different turning segments comprise segments with differently oriented 90 degree turns.

Example 13: The system of any of Examples 1-12, wherein the slot antenna includes three different slots that correspond to, and that mirror in position, the at least three straight segments and the at least two different turning segments of the antenna arm.

Example 14: A mobile electronic device may include: a main logic board (MLB) that includes a ground plane, an antenna feed electrically connected to the MLB, an antenna arm electrically connected to the antenna feed, and a slot antenna formed into at least a portion of the MLB, wherein the slot antenna is electrically connected to the antenna feed.

Example 15: The mobile electronic device of Example 14, wherein the antenna arm and the slot antenna are operated simultaneously as a combined antenna fed by the antenna feed.

Example 16: The mobile electronic device of Example 14 or Example 15, wherein a first resonance of the combined antenna is tunable by changing one or more characteristics of the antenna arm.

Example 17: The mobile electronic device of any of Examples 14-16, wherein a second resonance of the combined antenna is tunable by changing one or more characteristics of the ground plane of the MLB.

Example 18: The mobile electronic device of any of Examples 14-17, wherein the combined antenna is dimensioned to operate as a wideband antenna for mmWave frequencies.

Example 19: The mobile electronic device of any of Examples 14-18, wherein the mobile electronic device includes a plurality of combined antennas arranged in an array on the mobile electronic device.

Example 20: An apparatus may include: a main logic board (MLB) that includes a ground plane, an antenna feed electrically connected to the MLB, an antenna arm electrically connected to the antenna feed, and a slot antenna formed into at least a portion of the MLB, wherein the slot antenna is electrically connected to the antenna feed.

Embodiments of the present disclosure may include or be implemented in conjunction with various types of artificial-reality systems. Artificial reality is a form of reality that has been adjusted in some manner before presentation to a user, which may include, for example, a virtual reality, an augmented reality, a mixed reality, a hybrid reality, or some combination and/or derivative thereof. Artificial-reality content may include completely computer-generated content or computer-generated content combined with captured (e.g., real-world) content. The artificial-reality content may include video, audio, haptic feedback, or some combination thereof, any of which may be presented in a single channel or in multiple channels (such as stereo video that produces a three-dimensional (3D) effect to the viewer). Additionally, in some embodiments, artificial reality may also be associated with applications, products, accessories, services, or some combination thereof, that are used to, for example, create content in an artificial reality and/or are otherwise used in (e.g., to perform activities in) an artificial reality.

Artificial-reality systems may be implemented in a variety of different form factors and configurations. Some artificial-reality systems may be designed to work without near-eye displays (NEDs). Other artificial-reality systems may include an NED that also provides visibility into the real world (such as, e.g., augmented-reality system 800 in FIG. 8) or that visually immerses a user in an artificial reality (such as, e.g., virtual-reality system 900 in FIG. 9). While some artificial-reality devices may be self-contained systems, other artificial-reality devices may communicate and/or coordinate with external devices to provide an artificial-reality experience to a user. Examples of such external devices include handheld controllers, mobile devices, desktop computers, devices worn by a user, devices worn by one or more other users, and/or any other suitable external system.

Turning to FIG. 8, augmented-reality system 800 may include an eyewear device 802 with a frame 810 configured to hold a left display device 815(A) and a right display device 815(B) in front of a user's eyes. Display devices 815(A) and 815(B) may act together or independently to present an image or series of images to a user. While augmented-reality system 800 includes two displays, embodiments of this disclosure may be implemented in augmented-reality systems with a single NED or more than two NEDs.

In some embodiments, augmented-reality system 800 may include one or more sensors, such as sensor 840. Sensor 840 may generate measurement signals in response to motion of augmented-reality system 800 and may be located on substantially any portion of frame 810. Sensor 840 may represent one or more of a variety of different sensing mechanisms, such as a position sensor, an inertial measurement unit (IMU), a depth camera assembly, a structured light emitter and/or detector, or any combination thereof. In some embodiments, augmented-reality system 800 may or may not include sensor 840 or may include more than one sensor. In embodiments in which sensor 840 includes an IMU, the IMU may generate calibration data based on measurement signals from sensor 840. Examples of sensor 840 may include, without limitation, accelerometers, gyroscopes, magnetometers, other suitable types of sensors that detect motion, sensors used for error correction of the IMU, or some combination thereof.

In some examples, augmented-reality system 800 may also include a microphone array with a plurality of acoustic transducers 820(A)-820(J), referred to collectively as acoustic transducers 820. Acoustic transducers 820 may represent transducers that detect air pressure variations induced by sound waves. Each acoustic transducer 820 may be configured to detect sound and convert the detected sound into an electronic format (e.g., an analog or digital format). The microphone array in FIG. 8 may include, for example, ten acoustic transducers: 820(A) and 820(B), which may be designed to be placed inside a corresponding ear of the user, acoustic transducers 820(C), 820(D), 820(E), 820(F), 820(G), and 820(H), which may be positioned at various locations on frame 810, and/or acoustic transducers 820(I) and 820(J), which may be positioned on a corresponding neckband 805.

In some embodiments, one or more of acoustic transducers 820(A)-(J) may be used as output transducers (e.g., speakers). For example, acoustic transducers 820(A) and/or 820(B) may be earbuds or any other suitable type of headphone or speaker.

The configuration of acoustic transducers 820 of the microphone array may vary. While augmented reality system 800 is shown in FIG. 8 as having ten acoustic transducers 820, the number of acoustic transducers 820 may be greater or less than ten. In some embodiments, using higher numbers of acoustic transducers 820 may increase the amount of audio information collected and/or the sensitivity and accuracy of the audio information. In contrast, using a lower number of acoustic transducers 820 may decrease the computing power required by an associated controller 850 to process the collected audio information. In addition, the position of each acoustic transducer 820 of the microphone array may vary. For example, the position of an acoustic transducer 820 may include a defined position on the user, a defined coordinate on frame 810, an orientation associated with each acoustic transducer 820, or some combination thereof.

Acoustic transducers 820(A) and 820(B) may be positioned on different parts of the user's ear, such as behind the pinna, behind the tragus, and/or within the auricle or fossa. Or, there may be additional acoustic transducers 820 on or surrounding the ear in addition to acoustic transducers 820 inside the ear canal. Having an acoustic transducer 820 positioned next to an ear canal of a user may enable the microphone array to collect information on how sounds arrive at the ear canal. By positioning at least two of acoustic transducers 820 on either side of a user's head (e.g., as binaural microphones), augmented reality system 800 may simulate binaural hearing and capture a 3D stereo sound field around about a user's head. In some embodiments, acoustic transducers 820(A) and 820(B) may be connected to augmented-reality system 800 via a wired connection 830, and in other embodiments acoustic transducers 820(A) and 820(B) may be connected to augmented-reality system 800 via a wireless connection (e.g., a BLUETOOTH connection). In still other embodiments, acoustic transducers 820(A) and 820(B) may not be used at all in conjunction with augmented-reality system 800.

Acoustic transducers 820 on frame 810 may be positioned in a variety of different ways, including along the length of the temples, across the bridge, above or below display devices 815(A) and 815(B), or some combination thereof. Acoustic transducers 820 may also be oriented such that the microphone array is able to detect sounds in a wide range of directions surrounding the user wearing the augmented reality system 800. In some embodiments, an optimization process may be performed during manufacturing of augmented-reality system 800 to determine relative positioning of each acoustic transducer 820 in the microphone array.

In some examples, augmented-reality system 800 may include or be connected to an external device (e.g., a paired device), such as neckband 805. Neckband 805 generally represents any type or form of paired device. Thus, the following discussion of neckband 805 may also apply to various other paired devices, such as charging cases, smart watches, smart phones, wrist bands, other wearable devices, hand-held controllers, tablet computers, laptop computers, other external compute devices, etc.

As shown, neckband 805 may be coupled to eyewear device 802 via one or more connectors. The connectors may be wired or wireless and may include electrical and/or non-electrical (e.g., structural) components. In some cases, eyewear device 802 and neckband 805 may operate independently without any wired or wireless connection between them. While FIG. 8 illustrates the components of eyewear device 802 and neckband 805 in example locations on eyewear device 802 and neckband 805, the components may be located elsewhere and/or distributed differently on eyewear device 802 and/or neckband 805. In some embodiments, the components of eyewear device 802 and neckband 805 may be located on one or more additional peripheral devices paired with eyewear device 802, neckband 805, or some combination thereof.

Pairing external devices, such as neckband 805, with augmented-reality eyewear devices may enable the eyewear devices to achieve the form factor of a pair of glasses while still providing sufficient battery and computation power for expanded capabilities. Some or all of the battery power, computational resources, and/or additional features of augmented-reality system 800 may be provided by a paired device or shared between a paired device and an eyewear device, thus reducing the weight, heat profile, and form factor of the eyewear device overall while still retaining desired functionality. For example, neckband 805 may allow components that would otherwise be included on an eyewear device to be included in neckband 805 since users may tolerate a heavier weight load on their shoulders than they would tolerate on their heads. Neckband 805 may also have a larger surface area over which to diffuse and disperse heat to the ambient environment. Thus, neckband 805 may allow for greater battery and computation capacity than might otherwise have been possible on a stand-alone eyewear device. Since weight carried in neckband 805 may be less invasive to a user than weight carried in eyewear device 802, a user may tolerate wearing a lighter eyewear device and carrying or wearing the paired device for greater lengths of time than a user would tolerate wearing a heavy standalone eyewear device, thereby enabling users to more fully incorporate artificial-reality environments into their day-to-day activities.

Neckband 805 may be communicatively coupled with eyewear device 802 and/or to other devices. These other devices may provide certain functions (e.g., tracking, localizing, depth mapping, processing, storage, etc.) to augmented-reality system 800. In the embodiment of FIG. 8, neckband 805 may include two acoustic transducers (e.g., 820(I) and 820(J)) that are part of the microphone array (or potentially form their own microphone subarray). Neckband 805 may also include a controller 825 and a power source 835.

Acoustic transducers 820(I) and 820(J) of neckband 805 may be configured to detect sound and convert the detected sound into an electronic format (analog or digital). In the embodiment of FIG. 8, acoustic transducers 820(I) and 820(J) may be positioned on neckband 805, thereby increasing the distance between the neckband acoustic transducers 820(I) and 820(J) and other acoustic transducers 820 positioned on eyewear device 802. In some cases, increasing the distance between acoustic transducers 820 of the microphone array may improve the accuracy of beamforming performed via the microphone array. For example, if a sound is detected by acoustic transducers 820(C) and 820(D) and the distance between acoustic transducers 820(C) and 820(D) is greater than, e.g., the distance between acoustic transducers 820(D) and 820(E), the determined source location of the detected sound may be more accurate than if the sound had been detected by acoustic transducers 820(D) and 820(E).

Controller 825 of neckband 805 may process information generated by the sensors on neckband 805 and/or augmented-reality system 800. For example, controller 825 may process information from the microphone array that describes sounds detected by the microphone array. For each detected sound, controller 825 may perform a direction-of-arrival (DOA) estimation to estimate a direction from which the detected sound arrived at the microphone array. As the microphone array detects sounds, controller 825 may populate an audio data set with the information. In embodiments in which augmented-reality system 800 includes an inertial measurement unit, controller 825 may compute all inertial and spatial calculations from the IMU located on eyewear device 802. A connector may convey information between augmented-reality system 800 and neckband 805 and between augmented-reality system 800 and controller 825. The information may be in the form of optical data, electrical data, wireless data, or any other transmittable data form. Moving the processing of information generated by augmented-reality system 800 to neckband 805 may reduce weight and heat in eyewear device 802, making it more comfortable to the user.

Power source 835 in neckband 805 may provide power to eyewear device 802 and/or to neckband 805. Power source 835 may include, without limitation, lithium-ion batteries, lithium-polymer batteries, primary lithium batteries, alkaline batteries, or any other form of power storage. In some cases, power source 835 may be a wired power source. Including power source 835 on neckband 805 instead of on eyewear device 802 may help better distribute the weight and heat generated by power source 835.

As noted, some artificial-reality systems may, instead of blending an artificial reality with actual reality, substantially replace one or more of a user's sensory perceptions of the real world with a virtual experience. One example of this type of system is a head-worn display system, such as virtual-reality system 900 in FIG. 9, that mostly or completely covers a user's field of view. Virtual-reality system 900 may include a front rigid body 902 and a band 904 shaped to fit around a user's head. Virtual-reality system 900 may also include output audio transducers 906(A) and 906(B). Furthermore, while not shown in FIG. 9, front rigid body 902 may include one or more electronic elements, including one or more electronic displays, one or more inertial measurement units (IMUs), one or more tracking emitters or detectors, and/or any other suitable device or system for creating an artificial-reality experience.

Artificial-reality systems may include a variety of types of visual feedback mechanisms. For example, display devices in augmented-reality system 800 and/or virtual-reality system 900 may include one or more liquid crystal displays (LCDs), light emitting diode (LED) displays, microLED displays, organic LED (OLED) displays, digital light projector (DLP) micro-displays, liquid crystal on silicon (LCoS) micro-displays, and/or any other suitable type of display screen. These artificial-reality systems may include a single display screen for both eyes or may provide a display screen for each eye, which may allow for additional flexibility for varifocal adjustments or for correcting a user's refractive error. Some of these artificial-reality systems may also include optical subsystems having one or more lenses (e.g., concave or convex lenses, Fresnel lenses, adjustable liquid lenses, etc.) through which a user may view a display screen. These optical subsystems may serve a variety of purposes, including to collimate (e.g., make an object appear at a greater distance than its physical distance), to magnify (e.g., make an object appear larger than its actual size), and/or to relay (to, e.g., the viewer's eyes) light. These optical subsystems may be used in a non-pupil-forming architecture (such as a single lens configuration that directly collimates light but results in so-called pincushion distortion) and/or a pupil-forming architecture (such as a multi-lens configuration that produces so-called barrel distortion to nullify pincushion distortion).

In addition to or instead of using display screens, some of the artificial-reality systems described herein may include one or more projection systems. For example, display devices in augmented-reality system 800 and/or virtual-reality system 900 may include micro-LED projectors that project light (using, e.g., a waveguide) into display devices, such as clear combiner lenses that allow ambient light to pass through. The display devices may refract the projected light toward a user's pupil and may enable a user to simultaneously view both artificial-reality content and the real world. The display devices may accomplish this using any of a variety of different optical components, including waveguide components (e.g., holographic, planar, diffractive, polarized, and/or reflective waveguide elements), light-manipulation surfaces and elements (such as diffractive, reflective, and refractive elements and gratings), coupling elements, etc. Artificial-reality systems may also be configured with any other suitable type or form of image projection system, such as retinal projectors used in virtual retina displays.

The artificial-reality systems described herein may also include various types of computer vision components and subsystems. For example, augmented-reality system 800 and/or virtual-reality system 900 may include one or more optical sensors, such as two-dimensional (2D) or 3D cameras, structured light transmitters and detectors, time-of-flight depth sensors, single-beam or sweeping laser rangefinders, 3D LiDAR sensors, and/or any other suitable type or form of optical sensor. An artificial-reality system may process data from one or more of these sensors to identify a location of a user, to map the real world, to provide a user with context about real-world surroundings, and/or to perform a variety of other functions.

The artificial-reality systems described herein may also include one or more input and/or output audio transducers. Output audio transducers may include voice coil speakers, ribbon speakers, electrostatic speakers, piezoelectric speakers, bone conduction transducers, cartilage conduction transducers, tragus-vibration transducers, and/or any other suitable type or form of audio transducer. Similarly, input audio transducers may include condenser microphones, dynamic microphones, ribbon microphones, and/or any other type or form of input transducer. In some embodiments, a single transducer may be used for both audio input and audio output.

In some embodiments, the artificial-reality systems described herein may also include tactile (i.e., haptic) feedback systems, which may be incorporated into headwear, gloves, bodysuits, handheld controllers, environmental devices (e.g., chairs, floor mats, etc.), and/or any other type of device or system. Haptic feedback systems may provide various types of cutaneous feedback, including vibration, force, traction, texture, and/or temperature. Haptic feedback systems may also provide various types of kinesthetic feedback, such as motion and compliance. Haptic feedback may be implemented using motors, piezoelectric actuators, fluidic systems, and/or a variety of other types of feedback mechanisms. Haptic feedback systems may be implemented independent of other artificial-reality devices, within other artificial-reality devices, and/or in conjunction with other artificial-reality devices.

By providing haptic sensations, audible content, and/or visual content, artificial-reality systems may create an entire virtual experience or enhance a user's real-world experience in a variety of contexts and environments. For instance, artificial-reality systems may assist or extend a user's perception, memory, or cognition within a particular environment. Some systems may enhance a user's interactions with other people in the real world or may enable more immersive interactions with other people in a virtual world. Artificial-reality systems may also be used for educational purposes (e.g., for teaching or training in schools, hospitals, government organizations, military organizations, business enterprises, etc.), entertainment purposes (e.g., for playing video games, listening to music, watching video content, etc.), and/or for accessibility purposes (e.g., as hearing aids, visual aids, etc.). The embodiments disclosed herein may enable or enhance a user's artificial-reality experience in one or more of these contexts and environments and/or in other contexts and environments.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A system comprising:
a main logic board (MLB) that includes a ground plane;
an antenna feed electrically connected to the MLB;
an antenna arm electrically connected to the antenna feed; and
a slot antenna formed into at least a portion of the MLB, wherein the slot antenna is electrically connected to the antenna feed.

2. The system of claim 1, wherein the antenna arm comprises a monopole antenna.

3. The system of claim 1, wherein the antenna arm is formed in a specified shape and with specified dimensions.

4. The system of claim 3, wherein the slot antenna is formed in a shape that mirrors the specified shape of the antenna arm.

5. The system of claim 3, wherein the slot antenna is formed in a shape that mirrors the specified shape and the specified dimensions of the antenna arm.

6. The system of claim 1, wherein the antenna arm and the slot antenna are operated simultaneously as a combined antenna fed by the antenna feed.

7. The system of claim 6, wherein a higher impedance value of the slot antenna and a lower impedance value of the antenna arm combine to exhibit an intermediary impedance value that is between the higher and lower impedance values.

8. The system of claim 7, wherein the intermediary impedance value applies to a plurality of different wireless frequency bands.

9. The system of claim 6, wherein the combined antenna is inherently matched, such that the combined antenna is configured to function without an impedance matching circuit on the MLB.

10. The system of claim 6, wherein the antenna arm and the slot antenna of the combined antenna are configured in parallel.

11. The system of claim 1, wherein the antenna arm includes at least three straight segments that are intermediated by at least two different turning segments.

12. The system of claim 11, wherein the at least two different turning segments comprise segments with differently oriented 90 degree turns.

13. The system of claim 11, wherein the slot antenna includes three different slots that correspond to, and that mirror in position, the at least three straight segments and the at least two different turning segments of the antenna arm.

14. A mobile electronic device comprising:
a main logic board (MLB) that includes a ground plane;
an antenna feed electrically connected to the MLB;
an antenna arm electrically connected to the antenna feed; and
a slot antenna formed into at least a portion of the MLB, wherein the slot antenna is electrically connected to the antenna feed.

15. The mobile electronic device of claim 14, wherein the antenna arm and the slot antenna are operated simultaneously as a combined antenna fed by the antenna feed.

16. The mobile electronic device of claim 15, wherein a first resonance of the combined antenna is tunable by changing one or more characteristics of the antenna arm.

17. The mobile electronic device of claim 15, wherein a second resonance of the combined antenna is tunable by changing one or more characteristics of the ground plane of the MLB.

18. The mobile electronic device of claim 15, wherein the combined antenna is dimensioned to operate as a wideband antenna for mmWave frequencies.

19. The mobile electronic device of claim 15, wherein the mobile electronic device includes a plurality of combined antennas arranged in an array on the mobile electronic device.

20. An apparatus comprising:
a main logic board (MLB) that includes a ground plane;
an antenna feed electrically connected to the MLB;
an antenna arm electrically connected to the antenna feed; and
a slot antenna formed into at least a portion of the MLB, wherein the slot antenna is electrically connected to the antenna feed.
